(19) United States
(12) Patent Application Publication
(10) Pub. No.: US 2012/0275202 A1
(43) Pub. Date: Nov. 1, 2012

(54) SERIES MULTIPLEX POWER CONVERSION APPARATUS

(75) Inventors: Eiji YAMAMOTO, Fukuoka (JP); Ryuji SUENAGA, Fukuoka (JP); Takashi TANAKA, Fukuoka (JP); Taisuke KATAYAMA, Fukuoka (JP)

(73) Assignee: KABUSHIKI KAISHA YASKAWA DENKI, Kitakyushu-shi (JP)

(21) Appl. No.: 13/443,884

(22) Filed: Apr. 11, 2012

(30) Foreign Application Priority Data
Apr. 26, 2011 (JP) 2011-098229

(51) Int. Cl. H02M 7/5387; H02J 1/00

(52) U.S. Cl. 363/71; 363/65

(57) ABSTRACT

A series multiplex power conversion apparatus includes a plurality of phases. Each of the plurality of phases includes a plurality of power conversion cells coupled in series to each other. Each of the plurality of power conversion cells includes a current detector configured to detect a current through one phase among the plurality of phases corresponding to the current detector. Each of the plurality of power conversion cells is configured to independently stop a power conversion operation based on the current detected by the current detector.

### CROSS-REFERENCE TO RELATED APPLICATIONS

The present application claims priority under 35 U.S.C. §119 to Japanese Patent Application No. 2011-098229, filed Apr. 26, 2011. The contents of this application are incorporated herein by reference in their entirety.

### BACKGROUND OF THE INVENTION

1. Field of the Invention

The present invention relates to a series multiplex power conversion apparatus.

2. Discussion of the Background

Series multiplex power conversion apparatuses each include a plurality of phases. Each of the phases includes a plurality of power conversion cells coupled in series to each other. Examples of the series multiplex power conversion apparatuses include series multiple inverters, whose power conversion cells are low voltage single-phase inverters, which are referred to as cell inverters. The series multiple inverters use the cell inverters to directly obtain predetermined high pressure and high output power.

In relation to the series multiplex power conversion apparatuses, Japanese Unexamined Patent Application Publication No. 2009-106081 discloses detecting a phase current, which is on the side of power conversion cells coupled in series to each other, for the purpose of protecting overcurrent.

### SUMMARY OF THE INVENTION

According to one aspect of the present invention, a series multiplex power conversion apparatus includes a plurality of phases. Each of the plurality of phases includes a plurality of power conversion cells coupled in series to each other. Each of the plurality of power conversion cells includes a current detector configured to detect a current through one phase among the plurality of phases corresponding to the current detector. Each of the plurality of power conversion cells is configured to independently stop a power conversion operation based on the current detected by the current detector.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a diagram illustrating a series multiplex power conversion apparatus according to a first embodiment;

FIG. 2 is a diagram illustrating a power conversion cell shown in FIG. 1;

FIG. 3A is a diagram illustrating exemplary phase voltages generated by power conversion operations of power conversion cells;

FIG. 3B is a diagram illustrating other exemplary phase voltages generated by power conversion operations of the power conversion cells;

FIG. 3C is a diagram illustrating other exemplary phase voltages generated by power conversion operations of the power conversion cells;

FIG. 4 is a diagram illustrating an exemplary configuration of a power conversion unit shown in FIG. 2;

FIG. 5A is a diagram illustrating an exemplary state in which the power conversion unit shown in FIG. 4 stops a power conversion operation;

FIG. 5B is a diagram illustrating another exemplary state in which the power conversion unit shown in FIG. 4 stops a power conversion operation;

FIG. 6 is a diagram illustrating a flow of current between terminals in the state in which the power conversion unit shown in FIG. 4 stops the power conversion operation;

FIG. 7 is a diagram illustrating another exemplary configuration of the power conversion unit shown in FIG. 2;

FIG. 8A is a diagram illustrating an exemplary state in which the power conversion unit shown in FIG. 7 stops the power conversion operation;

FIG. 8B is a diagram illustrating another exemplary state in which the power conversion unit shown in FIG. 7 stops the power conversion operation;

FIG. 8C is a diagram illustrating another exemplary state in which the power conversion unit shown in FIG. 7 stops the power conversion operation;

FIG. 9 is a diagram illustrating an exemplary state in which the power conversion unit shown in FIG. 7 stops the power conversion operation; and

FIG. 10 is a diagram illustrating a series multiplex power conversion apparatus according to a second embodiment.

### DESCRIPTION OF THE EMBODIMENTS

The embodiments will now be described with reference to the accompanying drawings, wherein like reference numerals designate corresponding or identical elements throughout the various drawings.

The embodiments are directed to a series multiplex power conversion apparatus; however, the embodiments should not be construed in a limiting sense.

### First Embodiment

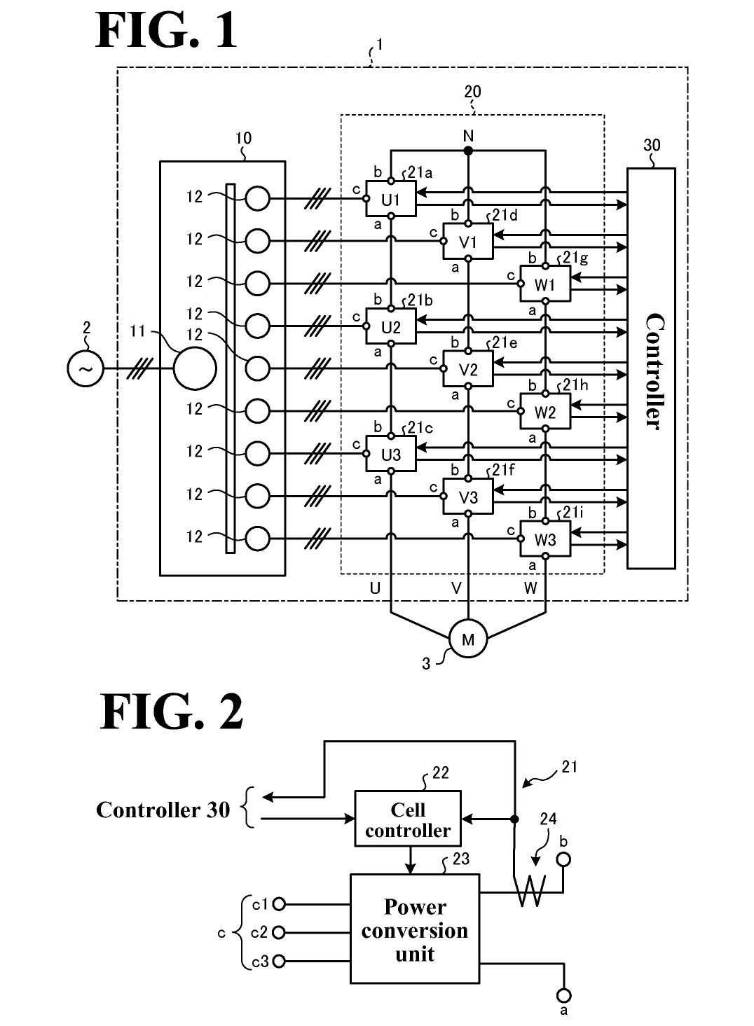

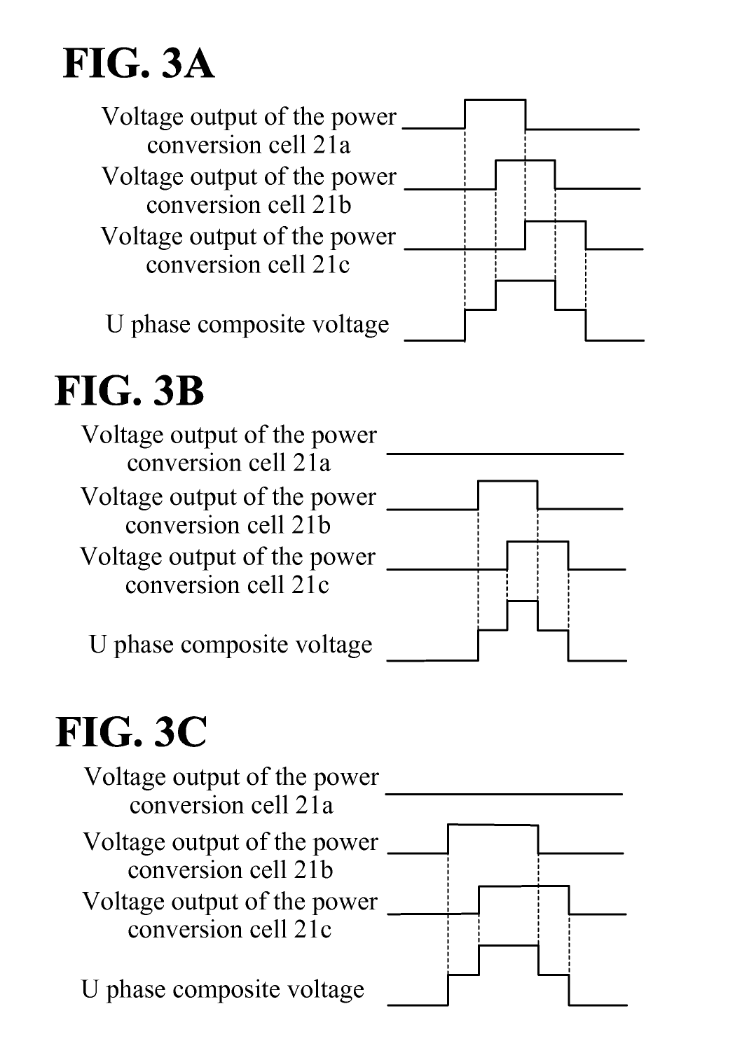

First, a series multiplex power conversion apparatus according to a first embodiment will be described. FIG. 1 is a diagram illustrating the series multiplex power conversion apparatus according to the first embodiment. FIG. 2 is a diagram illustrating an exemplary power conversion cell. FIGS. 3A to 3C are diagrams illustrating exemplary phase voltages formed by power conversion operations of power conversion cells. The horizontal axes of FIGS. 3A to 3C represent time axes drawn to the same scale.

As shown in FIG. 1, a series multiplex power conversion apparatus 1 is disposed between a three-phase alternating current power source 2 and an alternating current motor 3. The series multiplex power conversion apparatus 1 includes a transformer 10, a power conversion block 20, and a controller 30.

The transformer 10 includes a primary coil 11 and a plurality of secondary coils 12. The three-phase alternating current power source 2 is coupled to the primary coil 11. The power conversion block 20 includes power conversion cells 21a to 21i. Each of the power conversion cells 21a to 21i is coupled to a corresponding one of the plurality of secondary coils 12. The power conversion cells 21a to 21i will be hereinafter collectively referred to as power conversion cells 21.

When the power conversion cells 21 convert DC into AC, the transformer 10 is replaced by, for example, a direct current power source, which would be coupled to the power conversion cells 21. Even when the power conversion cells 21 directly convert AC into AC, the power conversion cells 21 may be directly coupled to the three-phase alternating current power source 2 without the intermediation by the transformer 10, depending on, for example, the relationship between the rated voltage on the three-phase alternating current power source 2 side and the rated voltage on the alternating current motor 3 side.

The power conversion block 20 includes a U phase, a V phase, and a W phase, which are coupled to each other in Y-connection at a phase difference of 120 degrees. Specifically, as described above, the power conversion block 20 includes the power conversion cells 21a to 21i. The U phase, the V phase, and the W phase each include three power conversion cells 21 coupled in series to each other. More specifically, the U phase includes three power conversion cells 21a to 21c coupled in series to each other, the V phase includes three power conversion cells 21d to 21f coupled in series to each other, and the W phase includes three power conversion cells 21g to 21i coupled in series to each other.

The controller 30 outputs a control signal to the power conversion cells 21. This ensures that the power conversion cells 21 each execute a power conversion operation based on the control signal. Examples of the control signal include, but not limited to, PWM signals.

Next, the configuration of the power conversion cell 21 will be described. As shown in FIG. 2, each power conversion cell 21 includes a cell controller 22 and a power conversion unit 23. The cell controller 22 controls the power conversion unit 23 based on the control signal output from the controller 30. The power conversion unit 23 is controlled by the cell controller 22 to execute a power conversion operation between terminals c1 to c3 (hereinafter also referred to as terminal c) and terminals a and b.

The power conversion cell 21 further includes a current detector 24 to detect a flow of current between the terminals a and b. This ensures detection of phase current independently on a single power conversion cell 21 basis. Specifically, the power conversion cells 21a to 21c each detect a current through the U phase, the power conversion cells 21d to 21f each detect a current through the V phase, and the power conversion cells 21g to 21i each detect a current through the W phase.

Based on the current detected by the current detector 24, the cell controller 22 stops the power conversion operation of the power conversion cell 21. Specifically, when the current detected by the current detector 24 is equal to or more than a predetermined threshold value while the cell controller 22 is controlling the power conversion unit 23 based on the control signal output from the controller 30, then the cell controller 22 determines that the power conversion unit 23 is in overcurrent state, and the cell controller 22 stops controlling the power conversion unit 23.

The current detected by the current detector 24 in the power conversion cell 21 is notified to the controller 30. Upon detection of a current equal to or more than the predetermined threshold value, the current detector 24 outputs an H-level detection signal, while upon detection of a current value smaller than the predetermined threshold value, the current detector 24 outputs an L-level detection signal.

Upon receipt of an H-level detection signal from the power conversion cell 21, the controller 30 outputs a changed control signal to the other power conversion cells 21 of the phase to which the power conversion cell 21 outputting the H-level detection signal belongs. For example, assume that all the power conversion cells 21a to 21c, which belong to the U phase, are under their respective power conversion operations. In this case, the power conversion cells 21a to 21c form a U phase composite voltage as shown in, for example, FIG. 3A.

In this state, assume that the power conversion cell 21a stops its power conversion operation due to detection of an overcurrent. In this case, the power conversion cells 21b and 21c form a U phase composite voltage as shown in, for example, FIG. 3B. Thus, power decreases in the U phase as compared with FIG. 3A.

In view of this, the controller 30 outputs a changed control signal to the other power conversion cells 21b and 21c of the U phase, to which the power conversion cell 21a belongs. Specifically, when the power conversion cell 21a stops its power conversion operation, the controller 30 outputs to the power conversion cells 21b and 21c a control signal that increases the average of the U phase composite voltage formed by the power conversion cells 21b and 21c shown in FIG. 3B. This ensures that in the U phase with the power conversion cell 21a stopping its power conversion operation, the amount of power to be converted by the power conversion cells 21b and 21c increases compared with the state shown in FIG. 3B.

For example, when the power conversion cell 21a stops its power conversion operation, the controller 30 may output to the power conversion cells 21b and 21c a control signal that makes the average of the U phase composite voltage formed by the power conversion cells 21b and 21c as shown in FIG. 3C, which equalizes the average of the U phase composite voltage shown in FIG. 3A. This ensures that in the U phase with the power conversion cell 21a stopping its power conversion operation, the amount of power to be converted by the power conversion cells 21b and 21c equalizes the state shown in FIG. 3A.

While the power conversion cell 21a has been exemplified as stopping its power conversion operation due to detection of an overcurrent, the controller 30 similarly controls the power conversion cells 21b and 21c when they stop their respective power conversion operations due to detection of an overcurrent. While the U phase has been described as the object of control, the controller 30 controls the V phase and the W phase in a similar manner to the manner in which the controller 30 controls the U phase. Thus, the controller 30 changes its control signal to output to the power conversion cells 21 in accordance with whether a power conversion cell 21 stops its power conversion operation in each of the U phase, the V phase, and the W phase.

While the above description is regarding a shift from the state shown in FIG. 3A through the state shown in FIG. 3C, it is also possible to maintain the state shown in FIG. 3B. That is, the controller 30 may output to the power conversion cells 21 a control signal that is independent of whether a power conversion cell 21 stops its power conversion operation in each of the U phase, the V phase, and the W -phase. While this reduces the amount of power to be converted, the processing load is taken off the controller 30.

Thus, the series multiplex power conversion apparatus 1 according to the first embodiment stops a power conversion operation independently on a power conversion cell 21 basis. Accordingly, while protection against overcurrent is ensured independently on a power conversion cell 21 basis, the entire operation continues by the remaining power conversion cells 21 that do not stop their respective power conversion operations. While in the above description the cell controller 22 of the power conversion cell 21 stops its power conversion operation based on the current detected by the current detector 24, this should not be construed in a limiting sense. For example, the controller 30 may stop the power conversion operation of the power conversion cell 21 based on the current detected by the current detector 24. Specifically, upon receipt of an H-level detection signal from a power conversion cell 21, the controller 30 may output a control signal (hereinafter referred to as a operation stop signal) that requires that the power conversion cell 21 outputting the H-level detection signal stop its power conversion operation.

In the series multiplex power conversion apparatus 1, a wiring inductance exists in cables that couple the power conversion cells 21 to each other, and variations exist among the elements constituting the power conversion cells 21. Due to the influence of the wiring inductance and due to the element variations, even power conversion cells 21 belonging to the same phase do not have identical currents. Accordingly, even if power conversion cells 21 belong to the same phase, one of the power conversion cells 21 might be determined as being in overcurrent state at a point of time while the other power conversion cell 21 might not be determined as being in overcurrent state at that point of time.

In view of this, the series multiplex power conversion apparatus 1 according to the first embodiment makes a determination as to the overcurrent state independently on a power conversion cell 21 basis, and stops the power conversion operation independently on a power conversion cell 21 basis based on the determination. Accordingly, while protection against overcurrent is ensured, the entire operation continues by the remaining power conversion cells 21 that belong to the phase of the power conversion cell 21 stopping its power conversion operation.

The independent stopping, on a power conversion cell 21 basis, of a power conversion operation associated with overcurrent is effective for the acceleration of the rotor of the alternating current motor 3, for example. The acceleration involves a temporary flow of excessive current, and if the excessive current causes the power conversion operation to stop on a phase basis, it is impossible to continue the power conversion. In view of this, the series multiplex power conversion apparatus 1 according to the first embodiment stops a power conversion operation independently on a power conversion cell 21 basis so as to ensure protection against overcurrent. Thus, the series multiplex power conversion apparatus 1 ensures a continued power conversion while ensuring protection against overcurrent.

The power conversion cells 21 each output information of the current detected by the corresponding current detector 24 (hereinafter referred to as detected current information) to the controller 30. Based on the detected current information output from the power conversion cells 21, the controller 30 determines whether there is a match among the phases as to the number of power conversion cells 21 stopping their respective power conversion operations. Upon determining that a discrepancy exists among the phases as to the number of power conversion cells 21 stopping their respective power conversion operations, the controller 30 stops the power conversion operation of at least one power conversion cell 21 among the power conversion cells 21 not stopping their respective power conversion operations. Thus, the controller 30 makes a match among the phases as to the number of power conversion cells 21 stopping their respective power conversion operations.

For example, assume that at first none of the power conversion cells 21a to 21i stops their respective power conversion operations, and that then the power conversion cell 21a, which belongs to the U phase, stops the power conversion operation of the power conversion cell 21a due to detection of a overcurrent. In this case, the controller 30 stops the power conversion operation of one of the power conversion cells 21 of the V phase, and stops the power conversion operation of one of the power conversion cells 21 of the W phase.

Specifically, the controller 30 outputs an operation stop signal to the power conversion cells 21 expected to stop their respective power conversion operations. Based on the operation stop signal, these power conversion cells 21 control their respective power conversion units 23 to stop their respective power conversion operations. Thus, making a match among the phases as to the number of power conversion cells 21 stopping their respective power conversion operations ensures a balance among the phases as to power conversion.

When making a match among the phases as to the number of power conversion cells 21 stopping their respective power conversion operations, the controller 30 makes a match among the phases as to the positions of the power conversion cells 21 stopping their respective power conversion operations. For example, assume that the power conversion cell 21a stops its power conversion operation due to detection of an overcurrent. The power conversion cell 21a, which is now stopping its power conversion operation, is located in the U phase at position U1 (see FIG. 1), which is the first stage relative to the neutral point N. In the V phase, position V1 corresponds to position U1 and is located at the first stage relative to the neutral point N. In the W phase, position W1 corresponding to position U1 and is located at the first stage relative to the neutral point N (see FIG. 1).

When, for example, the power conversion cell 21a stops its power conversion operation due to detection of an overcurrent, the controller 30 stops the power conversion operation of the power conversion cell 21d located at position V1, which corresponds in position to position U1 of the power conversion cell 21a, and stops the power conversion operation of the power conversion cell 21g located at position W1, which corresponds in position to position U1 of the power conversion cell 21a. Thus, making a match among the phases as to the positions of power conversion cells 21 stopping their respective power conversion operations ensures a balance among the phases as to power conversion more accurately.

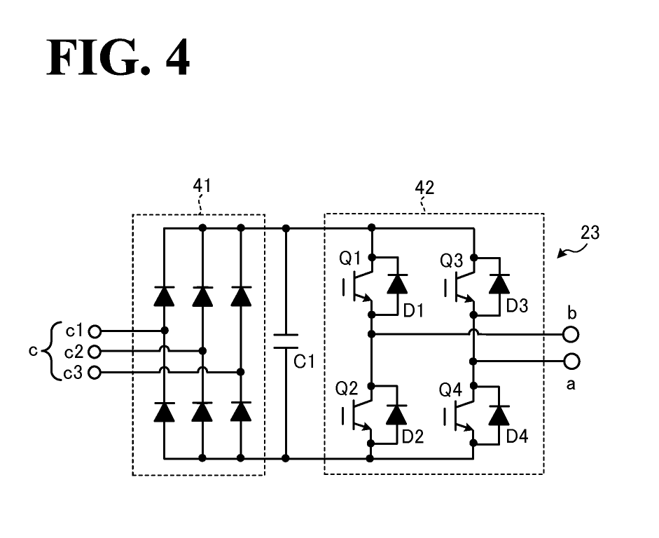

The configuration of the power conversion unit 23 will now be described in detail by referring to the drawings. In FIG. 4, an inverter is exemplified as the power conversion unit 23, while in FIG. 7, a matrix converter is exemplified as the power conversion unit 23.

First, description will be made with regard to an inverter serving as the power conversion unit 23 by referring to FIG. 4. The inverter shown in FIG. 4 includes a converter circuit 41, a capacitor C1, and an inverter circuit 42. Upon input of three-phase alternating current voltage into the terminal c from the three-phase alternating current power source 2 through the transformer 10, the converter circuit 41 rectifies three-phase alternating current voltage into direct current voltage. The capacitor C1 smoothes the direct current voltage rectified by the converter circuit 41.

While a full-wave rectifier circuit is exemplified as the converter circuit 41, this should not be construed as limiting the converter circuit 41. It is also possible to use and control switching elements to rectify alternating current power into direct current power.

The inverter circuit 42 switches the direct current voltage smoothed by the capacitor C1 and outputs current to the terminals a and b. The inverter circuit 42 includes four switching elements Q1 to Q4. Examples of the switching elements Q1 to Q4 include, but not limited to, semiconductor switches such as IGBT (Insulated Gate Bipolar Transistor).

Between the terminals a and b, a desired current flows at adjusted ON/OFF timings of the switching elements Q1 to Q4 by the control of the cell controller 22. In the inverter circuit 42, a high voltage side switching element Q1 and a low voltage side switching element Q2 are coupled in series to one another. Likewise, a high voltage side switching element Q3 and a low voltage side switching element Q4 are coupled in series to one another. The inverter circuit 42 also includes free wheel diodes D1 to D4 respectively coupled in parallel to the switching elements Q1 to Q4 between their respective output terminals, with the anode terminals of the free wheel diodes Dl to D4 located on the high voltage side.

When the current detected by the current detector 24 is equal to or more than a predetermined threshold, or when the controller 30 outputs an operation stop signal to the cell controller 22, then the cell controller 22 selectively executes one of a zero-potential-difference outputting operation and an all-switches-off operation. Information indicating whether to select the zero-potential-difference outputting operation or the all-switches-off operation is set in advance by, for example, being input in a setting unit, not shown. Based on the information thus set, the cell controller 22 selects one of the zero-potential-difference outputting operation and the all-switches-off operation.

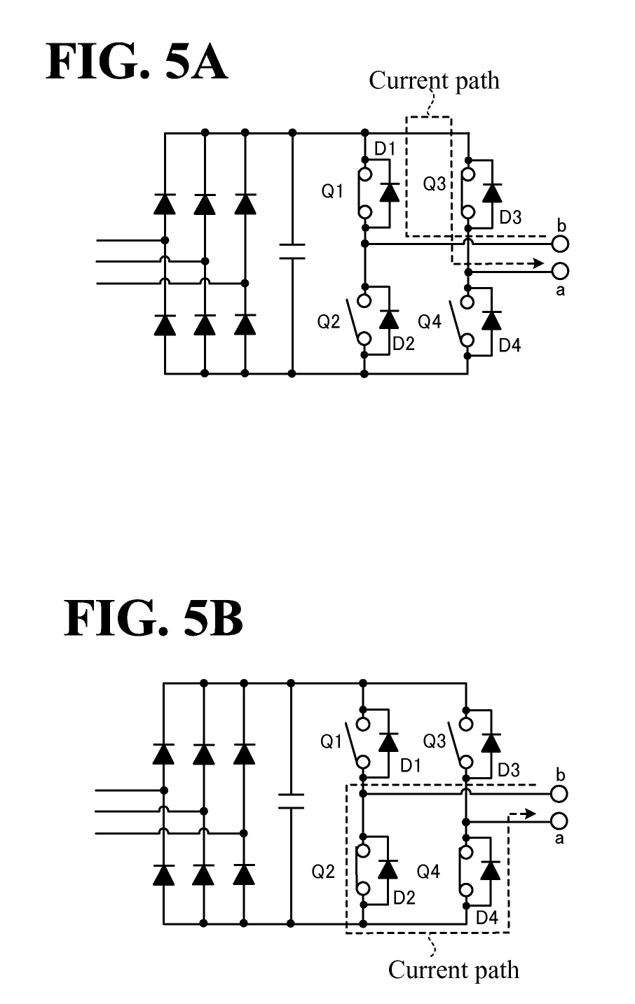

When selecting the zero-potential-difference outputting operation, the cell controller 22 controls the switching elements Q1 to Q4 between ON/OFF states, and thus makes the potential difference between the terminals a and b approximately zero. FIGS. 5A and 5B each show a state of approximately zero potential difference between the terminals a and b. For simplicity of description, FIGS. 5A and 5B illustrate the states of the switching elements Q1 to Q4 in simplified manners using general circuit symbols.

When selecting the zero-potential-difference outputting operation, the cell controller 22 makes the potential difference between the terminals a and b approximately zero by, for example, turning on all the high voltage side switching elements Q1 and Q3 while turning off all the low voltage side switching elements Q2 and Q4, as shown in FIG. 5A. In this case, the current flowing from the terminal b to the terminal a takes the path through the free wheel diode D1 and the switching element Q3, while the current flowing from the terminal a to the terminal b takes the path through the free wheel diode D3 and the switching element Q1. Thus, when the power conversion cell 21 stops its power conversion operation, conduction states are formed between the terminals a and b.

When one power conversion cell 21 in a phase stops the power conversion operation of the one power conversion cell 21 while the other power conversion cells 21 in the phase are under their respective power conversion operations, the other power conversion cells 21 are not influenced by the stopping of the power conversion operation of the one power conversion cell 21. Thus, the other power conversion cells 21 are able to continue their respective power conversion operations.

That is, the stopping of power conversion operation is on a power conversion cell 21 basis instead of on a phase basis. For example, when the power conversion cell 21a of the U phase stops the power conversion operation of the power conversion cell 21a, the power conversion cell 21a turns into conduction state. This ensures that the power conversion operations of the other power conversion cells 21b and 21c belonging to the U phase are not influenced by the stopping of the power conversion operation of the power conversion cell 21a. This ensures a continued power conversion operation in the U phase.

In order to make the potential difference between the terminals a and b approximately zero, the cell controller 22 may alternatively turn off all the high voltage side switching elements Q1 and Q3 while turning on all the low voltage side switching elements Q2 and Q4, as shown in FIG. 5B.

In this case, the current flowing from the terminal b to the terminal a takes the path through the switching element Q2 and the free wheel diode D4, while the current flowing from the terminal a to the terminal b takes the path through the switching element Q4 and the free wheel diode D2. Thus, when the power conversion cell 21 stops its power conversion operation, conduction states are formed between the terminals a and b. Thus, FIG. 5B is similar to FIG. 5A in that the stopping of power conversion operation is on a power conversion cell 21 basis instead of on a phase basis.

The cell controller 22 may select any one of the state shown in FIG. 5A and the state shown in FIG. 5B. It is also possible to, for example, switch between the switch control shown in FIG. 5A and the switch control shown in FIG. 5B every time an operation stop signal is input, so as to alternately repeat the switch control shown in FIG. 5A and the switch control shown in FIG. 5B. This eliminates or minimizes concentration of current to particular switching elements among the switching elements Q1 to Q4.

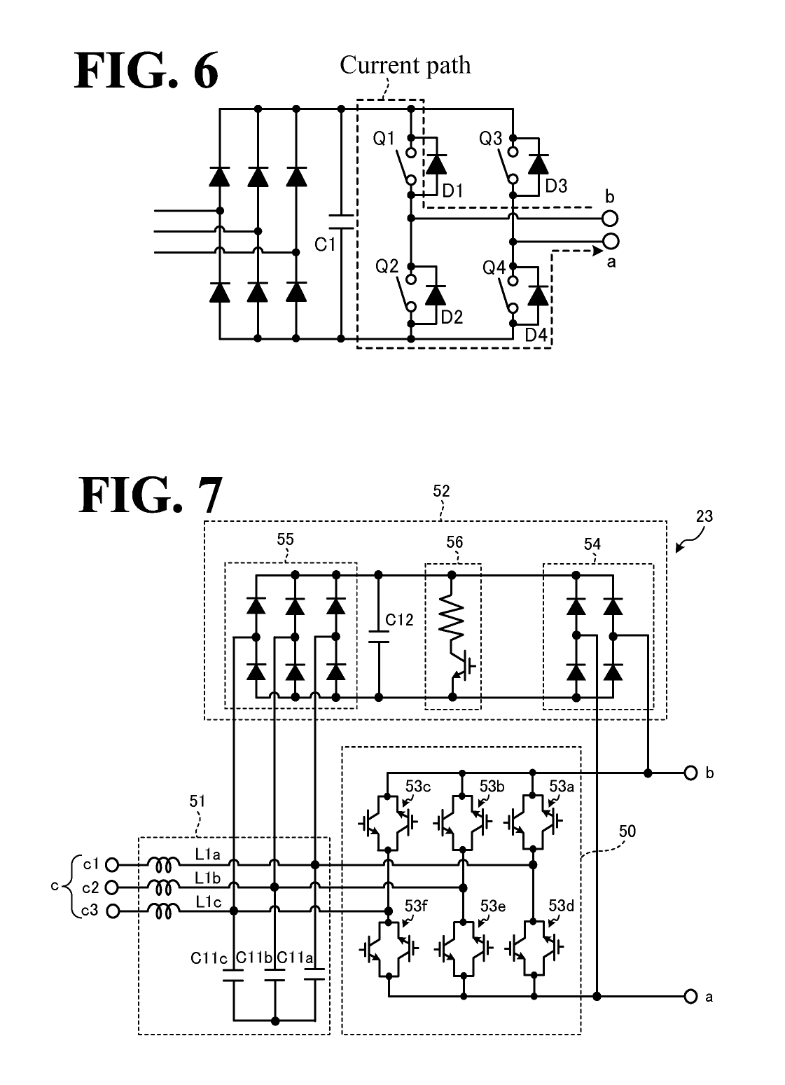

Next, description will be made with regard to the cell controller 22 selecting the all-switches-off operation. FIG. 6 is a diagram illustrating a state of the all-switches-off operation. For simplicity of description, FIG. 6 illustrates the states of the switching elements Q1 to Q4 in simplified manners using general circuit symbols, similarly to FIGS. 5A and 5B.

When selecting the all-switches-off operation, the cell controller 22 controls all the switching elements Q1 to Q4 to be turned off, as shown in FIG. 6. In this case, as shown in FIG. 6, the current flowing from the terminal b to the terminal a takes the path through the free wheel diode D1, the capacitor C1, and the free wheel diode D4.

The current flowing from the terminal a to the terminal b takes the path through the free wheel diode D3, the capacitor C1, and the free wheel diode D2. Thus, the all-switches-off operation is similar to the zero-potential-difference outputting operation in that the stopping of power conversion operation is on a power conversion cell 21 basis instead of on a phase basis.

In FIGS. 5A, 5B, and 6, the conduction states between the terminals a and b are formed by the zero-potential-difference outputting operation or the all-switches-off operation. This, however, should not be construed in a limiting sense. In an exemplary configuration where the power conversion cell 21 is unable to execute the zero-potential-difference outputting operation or the all-switches-off operation, it is possible to provide a separate switch between the terminals a and b. The switch may be turned on (turned into short circuit state) when the power conversion cell 21 stops its power conversion operation, so as to form a conduction state between the terminals a and b.

While in the above description the selection between the zero-potential-difference outputting operation and the all-switches-off operation is made based on information set in advance, this should not be construed as limiting the method for selection. For example, the cell controller 22 may execute the zero-potential-difference outputting operation when the current detected by the current detector 24 is equal to or more than a first threshold value and less than a second threshold value, while executing the all-switches-off operation when the current detected by the current detector 24 is equal to or more than the second threshold value. Alternatively, the cell controller 22 may execute the all-switches-off operation when the current detected by the current detector 24 is equal to or more than the first threshold value and less than the second threshold value, while executing the zero-potential-difference outputting operation when the current detected by the current detector 24 is equal to or more than the second threshold value. Alternatively, the cell controller 22 may alternately execute the zero-potential-difference outputting operation and the all-switches-off operation.

Next, description will be made with regard to a matrix converter serving as the power conversion unit 23 by referring to FIG. 7. The power conversion unit 23 shown in FIG. 7 is a single-phase matrix converter and includes a single-phase matrix converter main body 50, a filter 51, and a snubber circuit 52.

The single-phase matrix converter main body 50 includes bidirectional switches 53a to 53f. The bidirectional switches 53a, 52b, and 53c have their respective one ends coupled to the terminal b of the power conversion unit 23, while the bidirectional switches 53d, 53e, and 53f have their respective one ends coupled to the terminal a of the power conversion unit 23. The bidirectional switches 53a to 53f will be hereinafter occasionally collectively referred to as bidirectional switches 53.

The bidirectional switch 53a has its another end coupled to another end of the bidirectional switch 53d and to the terminal c1 through the filter 51. Similarly, the bidirectional switch 53b has its another end coupled to another end of the bidirectional switch 53e and to the terminal c2 through the filter 51. Similarly, the bidirectional switch 53c has its another end coupled to another end of the bidirectional switch 53f and to the terminal c3 through the filter 51.

The bidirectional switches 53a to 53f each include two single-direction switching elements that are coupled in parallel to one another and oriented in reverse directions. Examples of the switching elements include, but not limited to, semiconductor switches such as IGBT (Insulated Gate Bipolar Transistor). Each semiconductor switch is controlled between ON/OFF states by a control signal input at the gate, thereby controlling the current direction.

The filter 51 reduces harmonic currents generated by the switching of the single-phase matrix converter main body 50. The filter 51 includes capacitors C11a to C11c and inductances L1a to L1c. The inductances L1a to L1c are coupled between the single-phase matrix converter main body 50 and the terminals c1, c2 and c3. The capacitors C11a to C11c have their respective one ends coupled to the terminals c1, c2, and c3, and other ends coupled to each other.

The snubber circuit 52 includes an input side full-wave rectifier circuit 54, an output side full-wave rectifier circuit 55, a capacitor C12, and a discharge circuit 56. When surge voltage is generated between the terminals of the single-phase matrix converter main body 50, the snubber circuit 52 converts the surge voltage into direct current voltage at the input side full-wave rectifier circuit 54 and the output side full-wave rectifier circuit 55. The snubber circuit 52 accumulates the converted direct current voltage in the capacitor C12, and discharges the accumulated direct current voltage through the discharge circuit 56. The discharge circuit 56 is controlled by the cell controller 22 to execute the discharge when the voltage across the capacitor C12 becomes equal to or more than a predetermined value.

In the power conversion unit 23 thus configured, a desired current flows between the terminals a and b at adjusted ON/OFF timings of the bidirectional switches 53a to 53f by the control of the cell controller 22. Thus, the power conversion unit 23 executes the power conversion operation.

When the controller 30 outputs an operation stop signal to the cell controller 22, the cell controller 22 selectively executes one of the zero-potential-difference outputting operation and the all-switches-off operation. The method for selection between the zero-potential-difference outputting operation and the all-switches-off operation is similar to the method for selection associated with the above-described inverter.

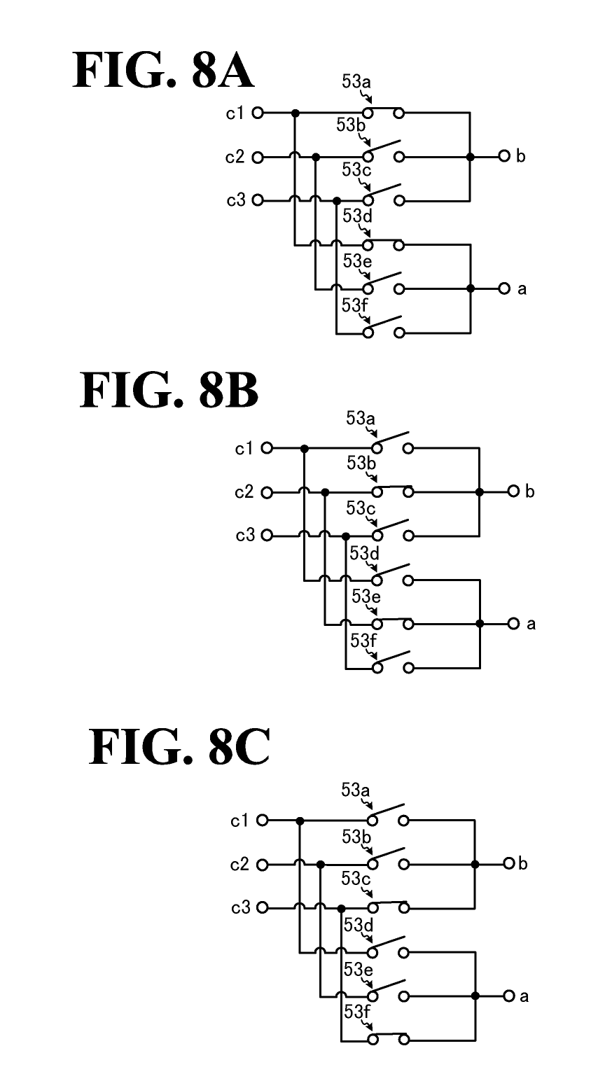

When selecting the zero-potential-difference outputting operation, the cell controller 22 controls the bidirectional switches 53a to 53f between ON/OFF states, and thus makes the potential difference between the terminals a and b approximately zero. FIGS. 8A to 8C each show a state of approximately zero potential difference between the terminals a and b. For simplicity of description, FIGS. 8A to 8C illustrate the states of the bidirectional switches 53a to 53f in simplified manners using general circuit symbols.

For example, as shown in FIG. 8A, the cell controller 22 turns on the bidirectional switches 53a and 53d, which are coupled to the terminal C1, in both bidirectional current directions. Contrarily, the cell controller 22 turns off the bidirectional switches 53b and 53e, which are coupled to the terminal c2, in both bidirectional current directions, and turns off the bidirectional switches 53c and 53f, which are coupled to the terminal c3, in both bidirectional current directions. In this case, the current flowing between the terminals a and b takes the path through the bidirectional switch 53a and the bidirectional switch 53b. This makes the potential difference between the terminals a and b approximately zero.

Alternatively, as shown in FIG. 8B, the cell controller 2 may turn on the bidirectional switches 53b and 53e, which are coupled to the terminal C2, in both bidirectional current directions. Contrarily, the cell controller 22 may turn off the bidirectional switches 53a and 53d, which are coupled to the terminal c1, in both bidirectional current directions, and turn off the bidirectional switches 53c and 53f, which are coupled to the terminal c3, in both bidirectional current directions. This also makes the potential difference between the terminals a and b approximately zero.

Alternatively, as shown in FIG. 8C, the cell controller 2 may turn on the bidirectional switches 53c and 53f, which are coupled to the terminal C3, in both bidirectional current directions. Contrarily, the cell controller 22 may turn off the bidirectional switches 53a and 53d, which are coupled to the terminal c1, in both bidirectional current directions, and turn off the bidirectional switches 53b and 53e, which are coupled to the terminal C2, in both bidirectional current directions. This also makes the potential difference between the terminals a and b approximately zero.

Thus, the cell controller 22 is able to make the potential difference between the terminals a and b approximately zero using any of the states shown in FIGS. 8A to 8C. If, however, the zero-potential-difference outputting operation continues for a substantial period of time, much load is placed on particular turned-on bidirectional switches 53. In view of this, the cell controller 22 switches the coupling state every time a predetermined period of time passes. This alleviates the load on the bidirectional switches 53.

For example, every time a predetermined period of time passes, the control state is switched from the control state shown in FIG. 8A to the control state shown in FIG. 8B, from the control state shown in FIG. 8B to the control state shown in FIG. 8C, and from the control state shown in FIG. 8C to the control state shown in FIG. 8A. This ensures that the bidirectional switches 53 through which current is allowed to flow are switched in the order of the bidirectional switches 53a and 53d, the bidirectional switches 53b and 53e, and the bidirectional switches 53c and 53f.

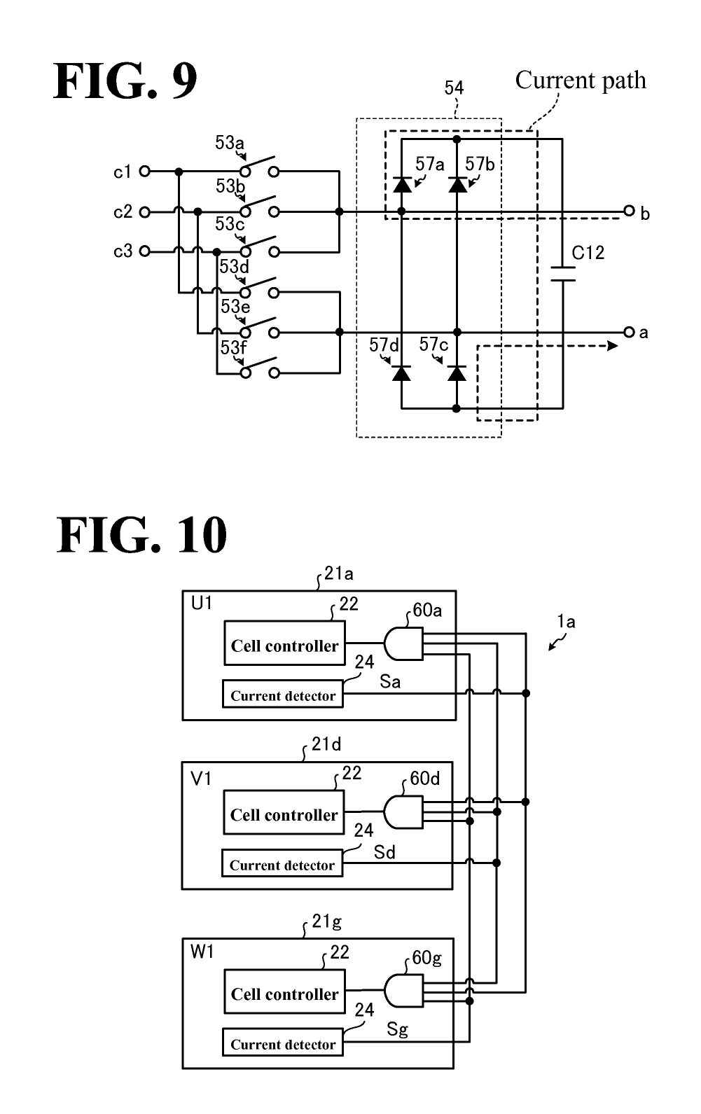

Next, description will be made with regard to the cell controller 22 selecting the all-switches-off operation. FIG. 9 is a diagram illustrating a state of the all-switches-off operation. For simplicity of description, FIG. 9 illustrates the states of the bidirectional switches 53a to 53f in simplified manners using general circuit symbols, similarly to FIG. 8.

When selecting the all-switches-off operation, the cell controller 22 controls the bidirectional switches 53a to 53f to be turned off in both bidirectional current directions, as shown in FIG. 9. In this case, as shown in FIG. 9, the current flowing from the terminal b to the terminal a takes the path through a diode 57a, the capacitor C12, and a diode 57c.

The current flowing from the terminal a to the terminal b takes the path through a diode 57b, the capacitor C12, and a diode 57d. Accordingly, the all-switches-off operation is similar to the zero-potential-difference outputting operation in that the stopping of power conversion operation is on a power conversion cell 21 basis instead of on a phase basis.

### Second Embodiment

Next, a series multiplex power conversion apparatus according to a second embodiment will be described. The series multiplex power conversion apparatus according to the second embodiment is different from the series multiplex power conversion apparatus 1 according to the first embodiment in the configuration of making a match among the phases as to the positions of power conversion cells 21 stopping their respective power conversion operations. (This processing will be hereinafter referred to as interphase cell position matching processing.) Specifically, in the series multiplex power conversion apparatus 1 according to the first embodiment, it is the controller 30 that executes the interphase cell position matching processing. In the series multiplex power conversion apparatus according to the second embodiment, the controller 30 is not involved in the interphase cell position matching processing.

FIG. 10 is a diagram illustrating a part of the configuration of the series multiplex power conversion apparatus according to the second embodiment. For simplicity of description, FIG. 10 only shows the power conversion cells 21a, 21d, and 21g and associated elements.

As shown in FIG. 10, a series multiplex power conversion apparatus 1a according to the second embodiment includes AND circuits 60a, 60d, and 60g. (The AND circuits 60a, 60d, and 60g will be hereinafter collectively referred to as AND circuits 60.) The AND circuits 60 receive a detection signal Sa output from the current detector 24 of a power conversion cell 21a located at position U1 of the U phase, a detection signal Sd output from the current detector 24 of a power conversion cell 21d located at position V1 of the V phase, and a detection signal Sg output from the current detector 24 of a power conversion cell 21g located at position W1 of the W phase.

When any one of the three detection signals Sa, Sd, and Sg is an H-level signal, the AND circuits 60 output H-level signals. When the AND circuits 60 output the H-level signals, the cell controllers 22 stop respective power conversion operations. Thus, when any one of the current detectors 24 of the power conversion cells 21a, 21d, and 21g outputs an H-level signal, the power conversion cells 21a, 21d, and 21g stop their respective power conversion operations.

For example, assume that the current detector 24 of the power conversion cell 21a outputs an H-level detection signal Sa, while the current detectors 24 of the power conversion cells 21d and 21g respectively output L-level detection signals Sd and Sg. In this case, the H-level detection signal Sa is input to the AND circuits 60a, 60d, and 60g, and in turn, the AND circuits 60a, 60d, and 60g output H-level signals. This causes the power conversion cells 21a, 21d, and 21g to stop their respective power conversion operations.

The embodiment of FIG. 10, which shows the power conversion cells 21a, 21d, and 21g, also applies to the power conversion cells 21b, 21e, and 21h respectively disposed at positions U2, V2, and W2 (see FIG. 1) located at the second stage relative to the neutral point. The embodiment of FIG. 10 also applies to the power conversion cells 21c, 21f, and 21i respectively disposed at positions U3, V3, and W3 (see FIG. 1) located at the third stage relative to the neutral point.

That is, when any one of the current detectors 24 of the power conversion cells 21b, 21e, and 21h outputs an H-level signal, the power conversion cells 21b, 21e, and 21h stop their respective power conversion operations. When any one of the current detectors 24 of the power conversion cells 21c, 21f, and 21i outputs an H-level signal, the power conversion cells 21c, 21f, and 21i stop their respective power conversion operations.

Thus, in the series multiplex power conversion apparatus 1a according to the second embodiment, one power conversion cell 21 of a phase stops the power conversion operation of the one power conversion cell 21 based on a result of detection by the current detector 24 of another power conversion cell 21 that belongs to another phase and that is disposed at a position in the other phase corresponding to the position of the one power conversion cell 21 in the one phase. This ensures a match among the phases as to the positions of power conversion cells 21 stopping their respective power conversion operations without control by the controller 30. While in FIG. 10 the AND circuits 60 are disposed in the respective power conversion cells 21, the AND circuits 60 may be disposed outside the respective power conversion cells 21.

Thus, the series multiplex power conversion apparatuses 1 and 1a respectively according to the first and second embodiments stop the power conversion operation on a power conversion cell 21 basis instead of on a phase basis. This ensures that even if some power conversion cell 21 executes protection against overcurrent, the entire operation continues by the remaining power conversion cells 21 that do not stop their respective power conversion operations.

While the first and second embodiments are regarding power conversion from the three-phase alternating current power source 2 to the alternating current motor 3, this should not be construed in a limiting sense. For example, the three-phase alternating current power source 2 may be replaced with an alternating current generator, while the alternating current motor 3 may be replaced with a power system. That is, the multiplex power conversion apparatus may also output power generated by the alternating current generator to the power system. In this case, when, for example, an inverter is used to serve as the power conversion cell 21, an inverter circuit is disposed on the terminal c side, while a converter circuit is disposed on the terminals a and b side.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A series multiplex power conversion apparatus comprising
a plurality of phases each comprising a plurality of power conversion cells coupled in series to each other, each of the plurality of power conversion cells comprising
a current detector configured to detect a current through one phase among the plurality of phases corresponding to the current detector, each of the plurality of power conversion cells being configured to independently stop a power conversion operation based on the current detected by the current detector.

2. The series multiplex power conversion apparatus according to claim 1, wherein each of the plurality of power conversion cells comprises a cell controller configured to stop the power conversion operation based on the current detected by the current detector.

3. The series multiplex power conversion apparatus according to claim 1, further comprising a controller configured to, based on the current detected by the current detector, stop the power conversion operation independently in one power conversion cell among the plurality of power conversion cells corresponding to the current detector.

4. The series multiplex power conversion apparatus according to claim 1, further comprising a controller configured to output a control signal to each of the plurality of power conversion cells of each of the plurality of phases, so as to control each of the plurality of power conversion cells to execute a power conversion operation based on the control signal, the controller being configured to change the control signal in accordance with whether a power conversion cell among the plurality of power conversion cells has stopped the power conversion operation in each of the plurality of phases.

5. The series multiplex power conversion apparatus according to claim 1, further comprising a controller configured to output a control signal to each of the plurality of power conversion cells of each of the plurality of phases, so as to control each of the plurality of power conversion cells to execute a power conversion operation based on the control signal, the controller being configured not to change the control signal in accordance with whether a power conversion cell among the plurality of power conversion cells has stopped the power conversion operation in each of the plurality of phases.

6. The series multiplex power conversion apparatus according to claim 1, wherein when a discrepancy exists among the plurality of phases as to number of power conversion cells stopping respective power conversion operations, at least one power conversion cell among power conversion cells not stopping the power conversion operation is configured to stop the power conversion operation, so as to make a match among the plurality of phases as to the number of power conversion cells stopping respective power conversion operations.

7. The series multiplex power conversion apparatus according to claim 6, wherein the plurality of phases are configured to make a match among the plurality of phases as to positions of the power conversion cells stopping the respective power conversion operations.

8. The series multiplex power conversion apparatus according to claim 2, wherein one power conversion cell among the plurality of power conversion cells of one phase among the plurality of phases is configured to stop the power conversion operation based on the current detected by the current detector of another power conversion cell that belongs to another phase and that is disposed at a position in the other phase corresponding to a position of the one power conversion cell in the one phase.

9. The series multiplex power conversion apparatus according to claim 3, wherein when one power conversion cell among the plurality of power conversion cells of one phase among the plurality of phases stops the power conversion operation, the controller is configured to stop a power conversion operation of another power conversion cell that belongs to another phase and that is disposed at a position in the other phase corresponding to a position of the one power conversion cell in the one phase.

10. The series multiplex power conversion apparatus according to claim 1, wherein each of the plurality of power conversion cells comprises an inverter.

11. The series multiplex power conversion apparatus according to claim 1, wherein each of the plurality of power conversion cells comprises a matrix converter.

12. The series multiplex power conversion apparatus according to claim 2, wherein when a discrepancy exists among the plurality of phases as to number of power conversion cells stopping respective power conversion operations, at least one power conversion cells among power conversion cells not stopping the power conversion operation is configured to stop the power conversion operation, so as to make a match among the plurality of phases as to the number of power conversion cells stopping respective power conversion operations.

13. The series multiplex power conversion apparatus according to claim 3, wherein when a discrepancy exists among the plurality of phases as to number of power conversion cells stopping respective power conversion operations, at least one power conversion cells among power conversion cells not stopping the power conversion operation is configured to stop the power conversion operation, so as to make a match among the plurality of phases as to the number of power conversion cells stopping respective power conversion operations.

14. The series multiplex power conversion apparatus according to claim 4, wherein when a discrepancy exists among the plurality of phases as to number of power conversion cells stopping respective power conversion operations, at least one power conversion cells among power conversion cells not stopping the power conversion operation is configured to stop the power conversion operation, so as to make a match among the plurality of phases as to the number of power conversion cells stopping respective power conversion operations.

15. The series multiplex power conversion apparatus according to claim 5, wherein when a discrepancy exists among the plurality of phases as to number of power conversion cells stopping respective power conversion operations, at least one power conversion cells among power conversion cells not stopping the power conversion operation is configured to stop the power conversion operation, so as to make a match among the plurality of phases as to the number of power conversion cells stopping respective power conversion operations.

16. The series multiplex power conversion apparatus according to claim 12, wherein the plurality of phases are configured to make a match among the plurality of phases as to positions of the power conversion cells stopping the respective power conversion operations.

17. The series multiplex power conversion apparatus according to claim 13, wherein the plurality of phases are configured to make a match among the plurality of phases as to positions of the power conversion cells stopping the respective power conversion operations.

18. The series multiplex power conversion apparatus according to claim 14, wherein the plurality of phases are configured to make a match among the plurality of phases as to positions of the power conversion cells stopping the respective power conversion operations.

19. The series multiplex power conversion apparatus according to claim 15, wherein the plurality of phases are configured to make a match among the plurality of phases as to positions of the power conversion cells stopping the respective power conversion operations.

20. The series multiplex power conversion apparatus according to claim 2, wherein each of the plurality of power conversion cells comprises an inverter.
